(19) United States
(12) Patent Application Publication
(10) Pub. No.: US 2025/0353558 A1
(43) Pub. Date: Nov. 20, 2025

(54) TRAILER

(71) Applicant: Expandable B.V., Eersel (NL)

(72) Inventors: Michiel Johannes Petrus BECX, Eersel (NL); Lucas Cornelis SPRUIJT, Eersel (NL)

(73) Assignee: Expandable B.V., Eersel (NL)

(21) Appl. No.: 18/867,615

(22) PCT Filed: May 16, 2023
(86) PCT No.: PCT/NL2023/050277

§ 371 Date: Nov. 20, 2024

(30) Foreign Application Priority Data
May 20, 2022 (NL) 2031950

(51) Int. Cl. B62D 63/06; B60S 9/04; B62D 53/06; B62D 61/12

(52) U.S. Cl. CPC B62D 63/061; B60S 9/04; B62D 53/062; B62D 61/12

(57) ABSTRACT

The invention relates to a trailer, in particular an expandable trailer, comprising: a trailer body, comprising a chassis and a bodywork, at least one wheel axle for at least one pair of wheels, wherein the wheel axle is displaceably coupled with the trailer body such that wheel axle is displaceable between an initial position and a stowed position.

The invention relates to a trailer, in particular an expandable trailer.

Expandable trailers are popular due to their multifunctionality and ease of use. Expandable trailers are trailers which could typically expand their volume by extending to one or two sides. Hence, during the transport the trailer can be in a relatively compact mode, whilst during use the volume, and thus the effective space which can be used, can be significantly increased. This results in the trailers being suitable and popular for several purposes, for example as mobile office, medical treatment room or for promotional purposes. The trailers are typically provided with at least one wheel axle comprising at least one pair of wheels as this contributes to the ease of use and flexibility thereof. An expandable trailer typically comprises extendable support elements, which can be applied to stabilize the trailer upon the ground or floor upon which it is positioned. The support elements can ensure that the trailer body is stable and stationary positioned in a substantially horizontal level. A drawback of the stationary position of conventional expandable trailers is that the bottom surface of the trailer is typically positioned at a substantial distance from ground level, namely above the wheel height of the trailer. This has the drawback that a height difference has to be overcome by the user when entering the trailer (body). This is typically done by a step or stairs. However, this could form a serious obstacle for users with mobility problems.

Hence, it is a goal of the invention to provide a solution for the abovementioned drawback or to at least provide an alternative for conventional (expandable) trailers.

The invention provides thereto a trailer, in particular an expandable trailer, comprising a trailer body, comprising a chassis and a bodywork, at least one wheel axle for at least one pair of wheels, and optionally at least one track, wherein at least one wheel axle is coupled to the trailer body via at least one track, and wherein the wheel axle is displaceable over said track at least between an initial position, wherein (at least part of) the wheel axle is positioned substantially underneath the chassis, and a stowed position, wherein the wheel axle is positioned outside a plane defined by the chassis.

The trailer according to the present invention has several benefits over conventional trailers. At first, at least one wheel axle being coupled with the trailer body via at least one track and said wheel axle being displaceable over said track enables that the position of the wheel axle with respect to the trailer body can be adjusted. Since the wheel axle is displaceable over the track at least between an initial position, wherein at least part of the wheel axle is positioned substantially underneath the chassis and a stowed position, wherein the wheel axle is positioned outside a plane defined by the chassis, it is achieved that the trailer can be in an initial, driving mode and a stowed, stationary mode. In the initial position of the wheel axle, thus the driving mode of the trailer, the wheel axle is positioned substantially underneath the chassis, such that the wheel axle according to the invention functions as a conventional wheel axle. However, when the wheel axle is in the stowed position, the wheel axle is positioned outside and/or at a distance from a plane defined by the chassis. This means that at least the area underneath the chassis is substantially free. The wheel axle will no longer be positioned underneath the chassis. This embodiment has the benefit that the chassis of the trailer body, and thus the overall trailer body, can be lowered, even up to ground level or floor level, without the wheel axle limiting the movement of the trailer body and/or restricting the (effective) volume of the trailer body. The latter is the case for conventional trailers which make use of a system wherein the chassis is lowered such that the wheels or wheel axle can be sunken into the trailer body. The wheels and/or wheel axle than negatively affect the effective usable volume of the trailer (body). The trailer according to the invention benefits of the fact that the volume of the trailer body is not negatively affected when the trailer body is lowered towards floor level or ground level. Since the wheel axle is located outside the plane defined by the chassis, the internal volume of the trailer body is not affected when the wheel axle is in its stowed position. When it is referred to a plane defined by the chassis, also the area defined by a footprint of the chassis can be meant, and in particular a volume defined by the footprint of the chassis and the vertical extension thereof. At least part of the track is preferably connected to the chassis.

It is beneficial to displace the wheel axle in its entirely, as is provided for in the present invention, as this results in that the wheels itself do not need to be disconnected. The relatively large wheels typically form a bottleneck for the vertical positioning of the chassis and it would be cumbersome to entirely disconnect the tires upon getting the trailer in a stationary mode. The provision of a displaceable wheel axle provides a relatively simple but effective solution. It is beneficial that at least one wheel axle is coupled to the trailer body via at least one track over which track the wheel axle is displaceable, since the track provides both guidance and outlining of the wheel axle with respect to the trailer body. The track in particular defines a route for the wheel axle. Hence, the wheel axle is displaceable over said track. It is also conceivable that displacement of the wheel axle is restricted by said track.

The wheel axle can be a conventional wheel axle, preferably comprising at least one pair of wheels. The invention also relates to a trailer comprising a wheel axle comprising at least one pair of wheels. The trailer according to the present invention is for example an unpowered trailer. Unpowered trailers benefit of being practical in use and maintenance. However, alternatively, it is also conceivable that a powered trailer is applied within the context of the present invention. When it is referred to a track, also a trail and/or rail can be meant.

It is in particular of interest that in the stowed position, the wheel axle is positioned outside a printout of a plane defined by the chassis. It can also be said that in the stowed position, the wheel axle is positioned outside a printout of the chassis. With a printout of the plane defined by the chassis, the area and/or volume directly at least underneath the chassis is meant. Alternatively, the wheel axle can be positioned outside the area and/or volume directly underneath and/or above the chassis. In case an expandable trailer is considered, the primary chassis in the unexpanded form is in particular meant. The invention basically also relates to a trailer, in particular an expandable trailer, comprising a trailer body, comprising a chassis and a bodywork, at least one wheel axle for at least one pair of wheels, wherein at least one wheel axle is coupled to the trailer body via at least one track, and wherein the wheel axle is displaceable over said track at least between an initial position, wherein (at least part of) the wheel axle is positioned substantially underneath the chassis, and a stowed position, wherein the wheel axle is positioned outside a printout of the chassis.

In a preferred embodiment of the trailer according to the present invention, at least part of the track is substantially parallel to the plane defined by the chassis and/or at least part of the track extends under an angle with respect to said plane. It is imaginable that the angle between the track and the plane is between 80° and 180°, preferably between 85° and 110°, more preferably between 85° and 100°. Such an embodiment is beneficial since it provides a maximum (effective) volume of the trailer body while the footprint of the trailer is minimal. It is also possible that at least part of the track extends in a direction away from the chassis. At least part of the track could for example extend in the direction of the bodywork. It is possible that at least a part of the track extends beyond at least one side of the chassis. Preferably, the trail extends beyond the rear side of the chassis.

It is also conceivable that the track is attached to the chassis and to at least part of the bodywork. Preferably, the part of the track attached to the chassis is longer than the part of the track attached to at least a part of the bodywork. The track can be attached to the chassis by means of a support structure, such as a crossbar or a mounting system. Preferably, the track is located on or close to the centreline of the chassis. It is conceivable that the track extends in longitudinal direction of the chassis. It is imaginable that the track is located in the chassis. The bodywork can for example be defined as a frame configured to accommodate side walls. The track can be attached to a part of the bodywork, for example by means of a connecting element, such as a crossbar or a mounting system. The bodywork of the trailer is in particular defined by multiple side walls. Typically, the side walls of the bodywork and chassis define volume of the trailer body. A top wall of the bodywork can also be seen as side wall. As indicated before, the trailer can be an expandable trailer. Hence, it is conceivable that at least the volume of the bodywork of the trailer, and thus the volume of the trailer body, is expandable. Preferably, the trailer is expandable in a transversal direction with respect to the chassis. The bottom surface of the trailer body is in an initial state defined by the chassis. However, in an expanded state, the bottom surface is defined by the chassis and the surface as defined by the expanded parts of the bodywork. The trailer, and in particular the chassis may comprise at least one slider configured to expand the volume of the trailer by extending in transversal direction with respect to the chassis.

In a beneficial embodiment, at least part of the track extends over a side wall of the bodywork. In this way the wheel axle can be displaced onto or at least the side wall. This results in a relatively practical embodiment, wherein the stowed position can be obtained in a relatively simple manner. It is for example also imaginable that a first part of the track is connected to the chassis and that a second part of the track is connected to the bodywork, and in particular to a side wall of the bodywork. A second part of the track can be connected to and located at distance from the chassis. It is also possible that a second part of the track is located in line with a plane defined by part of the bodywork. It is also imaginable that the second part of the track is releasably connected or attached to the bodywork. In this way, part of the track can be removed before transport of the trailer or for example to prevent the track from being exposed to weather influences when the trailer is for example parked but not in use. Preferably, the first part of the track is attached to the chassis in a fixed manner.

In a beneficial embodiment, at least part of at least one track is extendable in length. The track can for example be a telescopically extendable track. It is also conceivable that the track is a modular track. This could further contribute to the flexibility of use of the track and thus of the trailer as such.

At least one wheel axle is preferably displaceably connected to the track. Preferably at least part of the wheel axle substantially encloses the track. In this manner, the co-action between the wheel axle and the track can be further optimized. In an alternative embodiment, it is conceivable that at least one wheel axle comprises at least two axle parts. The wheel axle could for example comprise a right axle part and a left axle part which can be mutually connected at least in the initial position. Hence, it is conceivable that a right axle part and a left axle part are mutually connected in the initial position, or driving mode, but that the axle parts can be displaced individually. This could further optimize the ease of the use of the trailer.

The trailer can comprise at least one displacement element configured to enable displacement of at least one wheel axle with respect to the track. It is imaginable that the track and/or the wheel axle is/are connected to the displacement element. It is imaginable that the displacement element is fixedly connected to the wheel axle and displaceably connected to the track. The displacement element can be configured to relatively displace the track and the wheel axle, preferably such that the wheel axle can be displaced over the track at least between an initial position and a stowed position. Preferably, the displacement element is attached to or seized on an actuator configured to relatively displace the track and the wheel axle. It is possible that the actuator seizes on or is attached to the wheel axle, such that the actuator is configured to displace the wheel axle with respect to the track. Preferably, the actuator is configured to apply a pushing force to and/or a pulling force on the wheel axle and/or the displacement element. The actuator can for example be a manual actuator, an electric actuator, a pneumatic actuator or a hydraulic actuator. It is possible that the actuator is configured to linearly displace the displacement element, preferably such that the wheel axle is linearly displaced with respect to the track. The actuator can be received in an actuator bearing structure. The actuator bearing structure can at least partially be received in the chassis, in particular the actuator bearing structure can at least partially be received in the track. It is imaginable that the actuator bearing structure is configured to be displaced over the track. The displacement element can comprise one or more rollers, wheels, gearwheels, cogwheels, or sliders that are in contact with the track. It is imaginable that the displacement element is a chained displacement element. A chained displacement element is advantageous since it offers flexibility while maintaining its strength for the displacement of the wheel axle between the initial position and the stowed position. The displacement element can for example comprise a plurality of coupled links. It is imaginable that a plurality of links is coupled via a link connector which is connected to the track via at least one roller. Such embodiment can in particular enable that a relatively small extension of the wheel axle with respect to the trailer body is realized during displacement of the wheel axle into the stowed position.

Trailers typically comprise a guard or bumper at the rear end of the trailer, specifically at the rear end of the chassis of the trailer. Such guard or bumper has a protective function and is typically configured to form a physical barrier for example to keep smaller vehicles from going under the trailer. For the trailer according to the present invention, it is imaginable that the trailer comprises at least one detachable and/or displaceable guard. The guard can for example be detachably connected or connectable to the chassis. The use of at least one detachable and/or displaceable guard is beneficial since it enables to free the way for the wheel axle when said wheel axle is displaced from the initial position to the stowed position. In a possible embodiment, the guard can be detached from the trailer, and in particular from the chassis, such that the guard does not form an obstruction on the track. The guard is in a preferred embodiment configured to be connected to the chassis and/or to the wheel axle in a detachable manner. Hence, it is imaginable that the guard is connectable to both the chassis and to the wheel axle. In a preferred embodiment, the guard is configured to be detachably connected or connectable to the chassis in particular when the wheel axle is in the initial position and/or configured to be detachably connected or connectable to the wheel axle in particular when the wheel axle is in the stowed position. The guard can also be connected to the wheel axle in an intermediate position of the wheel axle between the initial position and the stowed position. In a further preferred embodiment, the guard is displaceable over at least part of the track. It is for example possible that the guard is connected to wheel axle and that the assembly of the guard and the wheel axle is displaced over the track. It is for example imaginable that the guard is displaceable at least between a driving configuration, wherein the guard is positioned at the rear end of the trailer, in particular at the rear end of the chassis, and a parked configuration, wherein the guard is positioned outside a plane defined by the chassis. It is advantageous if the guard is displaceable over the track since it decreases or, preferably, takes away the physical effort required to displace the guard to pave the way for the wheel axle. Preferably, the guard is displaceable over the track when attached to the wheel axle. The guard can for example be a rear impact guard, a rear underride guard, a Mansfield bar or a bumper for example a DOT bumper. When it is referred to a guard, also a bumper can be meant. The guard can for example comprise a structure comprising at least one beam and/or at least one crossbar. It is also imaginable that the guard comprises at least one bumper element.

In a further preferred embodiment, the guard comprises at least one primary coupling element which is configured to be coupled to the chassis. It is possible that the chassis comprises at least one primary counter coupling element configured to co-act with the coupling element of the guard. Preferably, the at least one primary counter coupling element is located at the rear end of the chassis. It is imaginable that the at least one primary coupling element of the guard is a bearing surface configured to at least partially carry the guard when attached to the chassis. It is possible that the at least one primary complementary coupling element of the chassis comprises an accommodation space configured to receive at least one bearing surface of the guard. It is beneficial if the guard comprises at least one primary coupling element to secure the guard in the initial position, or driving mode, preferably such that it can resist braking forces.

It is conceivable that the guard is detachably connected or connectable to the wheel axle. Preferably, the wheel axle comprises thereto at least one secondary coupling element configured for coupling with the guard. The at least one secondary coupling element of the wheel axle can be configured to be coupled to or to grip on at least a portion of the guard such as a beam or a crossbar. It is imaginable that the guard comprises a complementary secondary coupling element, or a secondary counter coupling element, configured to co-act with the secondary coupling element of the wheel axle. The secondary coupling element and/or the secondary counter coupling element can be a hook, a clamp, a receiving space, a protrusion, a groove, a holder or combination thereof. The advantage of a secondary coupling element is that the guard can be taken out of the way simultaneously with the wheel axle when the wheel axle displaces between the initial position and the stowed position. Additionally, the coupling of the wheel axle and the guard is beneficial since it forms an (compact) assembly of the wheel axle and the guard which results in a reduction of the footprint of the trailer in stowed position.

The wheel axle can optionally comprise a tertiary coupling element configured to couple to the guard. Preferably, the tertiary coupling element and the secondary coupling element are located at a distance from one another. It is imaginable that the guard comprises a complementary tertiary coupling element configured to co-act with the tertiary coupling element of the wheel axle. The tertiary coupling element can be a protruding element configured to be received in a receiving space in the guard or a receiving space configured to be received in a protruding element of the guard. Preferably, the tertiary coupling element is configured to apply a pushing force in the direction of the displacement of the wheel axle over the track.

It is imaginable that the trailer comprises at least one safety element or brake element configured to prevent the wheel axle, possibly in combination with the guard, to roll back when displaced towards the stowed position. In a preferred embodiment, at least one track comprises at least two track rails. At least one wheel axle can be positions such that each wheel of a pair of wheels is located substantially near a track rail. The use of at least two track rails could positively contribute to the stability of the overall configuration and/or for the better guidance of the wheel axle during displacement thereof. This embodiment is also of interest in case there is made use of a wheel axle comprises at least two axle parts. It is for example imaginable that the track comprises at least two track rails which are positioned substantially parallel to each other. It is also imaginable that the track comprises multiple track rails, wherein at least one track rail overlaps with another track rail.

The track could optionally define a channel. It is imaginable that the track comprises at least one track rail comprising a rail channel configured to receive at least a part of the displacement element, if applied. The rail channel could also be configured to receive at least part of one or more rollers, wheels, gearwheels, cogwheels or sliders. The rail channel can comprise at least one broadened portion configured to allow an upward movement of the displacement element, and preferably therewith allowing an upward movement of the wheel axle, in the initial position. This is beneficial because it reduces the force that is released on the track.

Trailers typically comprise a suspension system, typically comprising an air suspension. It is also imaginable that the trailer according to the present invention comprises an air suspension system. Typically, the air suspension is electronically (or alternatively manually) controlled and keeps the trailer at the same height regardless of the weight and position of the load and can also be used to regulate the height of the trailer. The air suspension system can typically be set in two different modes, drive mode or manual mode. Drive mode means that the trailer is ready for driving and the manual mode means that the system is ready to change the height of the trailer. The air suspension system can typically be adjusted, preferably manually, when the truck is substantially stationary. The trailer can for example be in an extended configuration, typically applied during driving, and a retracted configuration. In the retracted configuration, the trailer can then for example be lowered to its lowest and most compact configuration wherein the wheels are in their most compact position with respect to the wheel axle. It is desired that the trailer according to the present invention comprises at least one locking element for locking at least one wheel, and preferably all wheels with respect to the wheel axle, preferably at least in the retracted configuration. This is beneficial since such embodiment can prevent that the wheels as such can displace, in particular dropping down, during displacement of the wheel axle over the track.

Preferably, at least one wheel, and preferably each wheel is lockable with respect to the wheel axle. More preferably, at least one wheel and preferably each wheel is lockable with respect to the wheel axle at least in a retracted configuration. A locked configuration between the wheels and the wheel axle provides a reliable connection between said components of the trailers. The locking can for example be provided via complementary locking elements. Hence, it is conceivable that at least one wheel, and preferably each wheel and at least one wheel axle comprise complementary locking elements. It is also conceivable that the trailer comprises at least one locking element, preferably a mechanical locking element, for locking the position of at least one wheel with respect to the wheel axle. It is imaginable that the number of locking elements equals the number of wheels which need to be locked with respect to the wheel axle. The trailer can for example also comprise at least one securing element configured to secure the wheel axle at least in the initial position, preferably such that displacement of the wheel axle over the track is limited, more preferably such that displacement of the wheel axle over the track is blocked. It is imaginable that the at least one securing element is configured to secure the wheel axle to the track and/or to the chassis in the initial position. At least one securing element is preferably configurated to temporarily secure the wheel axle with respect to the track and/or the chassis. It is conceivable that the at least one securing element comprises a wheel axle securing part and a chassis securing part. Upon contact of the wheel axle securing part and the chassis securing part, preferably upon locking of the wheel axle securing part with the chassis securing part, the at least one securing element can be configured to lock the wheel axle to the chassis. The wheel axle securing part and the chassis securing part are preferably complementary shaped. It is possible that the at least one securing element is a mechanical securing element configured to lock the wheel axle in the initial position. The trailer can comprise a plurality of securing elements configured to lock the wheel axle in the initial position. The advantage of a trailer comprising at least one securing element is that the wheel axle is capable of resisting braking forces and therewith circumvent the wheel axle to be displaced over the track in the initial position or in the driving mode.

The trailer can comprise at least one stowed position securing element configured to secure at least one wheel axle in stowed position, preferably such that the displacement of the wheel axle over the track is limited, more preferably such that the displacement of the wheel axle over the track is blocked. It is possible that the stowed position securing element is configured to hold the wheel axle under an angle with respect to ground level, preferably to hold the wheel axle in the direction of the track or onto the track, more preferably to hold the wheel axle substantially vertical with respect to ground level. The stowed position securing element can for example seize on the axle of the wheel axle. It is imaginable that the at least one stowed position securing element is configured to lock the wheel axle to the track in the stowed position. The stowed position securing element can be a clamping element, a holder, a pressure element, such as a hydraulic pressure element or a spring, or a combination thereof, wherein the stowed position securing element is preferably configured to press the wheel axle towards the track. The advantage of a trailer comprising at least one stowed position securing element is that the wheel axle can be safely secured in stowed position by preventing that the wheel axle can be displaced over the track when the wheel axle is in the stowed position.

In a further possible embodiment, it is conceivable that the trailer comprises at least two wheel axles, wherein each wheel axle is coupled to the trailer body via at least one track and wherein each wheel axle is displaceable over at least part of the track at least between an initial position, wherein (at least part of) the wheel axles are positioned substantially underneath the chassis and a stowed position, wherein the wheel axle are positioned outside a plane defined by the chassis. In particular for trailers having a relatively large volume, the presence of at least two wheel axles can be beneficial for stability and support of the trailer. In case multiple wheel axles are applied, each wheel axle and corresponding track can be configured according to any of the described embodiments.

The trailer according to the invention preferably comprises at least one pair of extendable support members for supporting the trailer body, wherein the extendable support members are displaceable between an extended position and a retracted position. More preferably, the trailer comprises at least two pairs of extendable support members, wherein the extendable support members are displaceable between an extended position and a retracted position. The support members are typically extendable in vertical direction. The support members are preferably configured to enable vertical displacement of the trailer body, preferably at least from initial level to a level below said initial level. It is for example conceivable that the support members enable that the trailer body can be positioned substantially at or near ground level. It is also preferred that the support members are configured to lift the trailer body such that at least one pair of wheels will get loose from the ground. In this manner, displacement of the wheel axle, and thus of the wheels, is significantly simplified. At least one of the extendable support members can be a displaceable extendable support member, wherein the at least one displaceable extendable support member is configured to be displaced in a direction transversal to chassis. At least one displaceable extendable support member can for example be displaceable in a substantially horizontal direction. It is imaginable that at least one displaceable extendable support member is displaceable in transversal direction over the rear end of the chassis. Preferably, at least one displaceable extendable support member extends beyond the plane defined by the chassis. The use of displaceable extendable support members is beneficial since the space through which the wheel axle can be displaced between the initial position and the stowed position can be enlarged. Furthermore, the dimensions of the space through which the wheel axle can be displaced between the initial position and stowed position can be adapted to the dimensions of the wheel axle. Preferably, of at least one pair of extendable support members each support member is positioned at an opposing sides of the chassis. In case multiple pairs of support members are applied, preferably the support members are arranged in a spatial configuration, in particular such that the weight of the trailer body can be divided over said support members. Support members are preferably positioned at respective opposite sides of the central longitudinal axis of the chassis. Alternatively, the trailer could comprise at least three extendable support members. Extension of the extendable support members could for example be done manually and/or electronically. The support members could for example be telescopically extendable support members.

The volume of the trailer body of the trailer according to the present invention is preferably expandable. Hence, it is conceivable that the trailer body, and in particular the bodywork, comprises at least one pop out or slide out compartment. The presence of said displaceable compartment enables the that the volume of the trailer body can be expanded. It is for example also conceivable that the trailer comprises multiple displaceable compartments. It is possible that the trailer is at least expandable in transversal direction with respect to the chassis.

In a further possible embodiment, the trailer comprises at least one cover element configured for covering at least part of at least one wheel axle in the stowed position. The cover element could provide a protective function for at least part of the wheel axle.

The trailer could optionally comprise at least one control unit configured to control at least the displacement of at least one wheel axle with respect to the track. It is also conceivable that the control unit is configured to control the extension (and/or retraction) of the extendable support members, if applied. The application of at least one control unit can improve the user-friendly character of the trailer.

The invention further relates to an assembly, or a kit of parts, of at least one track and at least one wheel axle for use in trailer according to the present invention.

The invention will be further elucidated by means of the following non-limitative clauses.

1. Trailer, in particular an expandable trailer, comprising:
a trailer body, comprising a chassis and a bodywork;
at least one wheel axle for at least one pair of wheels;
wherein at least one wheel axle is coupled with the trailer body via at least one track; and
wherein the wheel axle is displaceable over said track at least between:
   an initial position, wherein at least part of the wheel axle is positioned substantially underneath the chassis; and
   a stowed position, wherein the wheel axle is positioned outside a plane defined by the chassis.

2. Trailer according to clause 1, wherein in the stowed position, the wheel axle is positioned outside a printout of a plane defined by the chassis.

3. Trailer according to clause 1 or clause 2, wherein at least part of the track is substantially parallel to the plane defined by the chassis and wherein at least part of the track extends under an angle with respect to said plane.

4. Trailer according to any of the previous clauses, wherein at least part of the track extends over a side wall of the bodywork.

5. Trailer according to any of the previous clauses, wherein a first part of the track is connected to the chassis and wherein a second part of the track is connected to the bodywork.

6. Trailer according to any of the previous clauses, wherein at least one track is extendable in length.

7. Trailer according to any of the previous clauses, wherein at least one track comprises at least two track rails.

8. Trailer according to any of the previous clauses, wherein at least one wheel axle is lockable with respect to the track at least in the initial position and/or in the stowed position.

9. Trailer according to any of the previous clauses, wherein at least one wheel axle comprises a right axle part and a left axle part which can be mutually connected at least in the initial position.

10. Trailer according to any of the previous clauses, comprising at least two wheel axles, wherein each wheel axle is coupled with the trailer body via at least one track and wherein each wheel axle is displaceable over at least part of the track at least between an initial position, wherein (at least part of) the wheel axles are positioned substantially underneath the chassis and a stowed position, wherein the wheel axle are positioned outside a plane defined by the chassis.

11. Trailer according to any of the previous clauses, comprising at least one pair of extendable support members for supporting the trailer body, wherein the extendable support members are displaceable between an extended position and a retracted position.

12. Trailer according to any of the previous clauses, wherein the volume of the trailer body is expandable.

13. Trailer according to any of the previous clauses, comprising at least one cover element configured for covering at least part of at least one wheel axle in the stowed position.

14. Trailer according to any of the previous clauses, wherein the trailer is an unpowered trailer.

15. Trailer according to any of the previous clauses, comprising at least one control unit which is configured to control at least the displacement of at least one wheel axle with respect to the track.

16. Assembly of at least one track and at least one wheel axle for use in trailer according to any of the previous clauses.

The invention will be further elucidated by means of non-limiting exemplary embodiments illustrated in the following figures, in which:

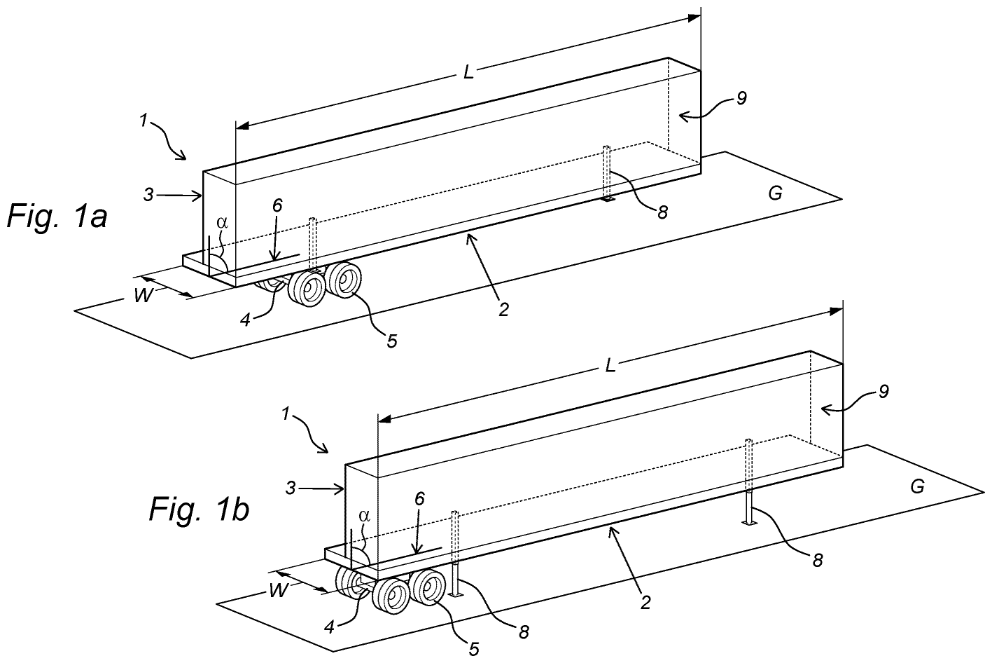

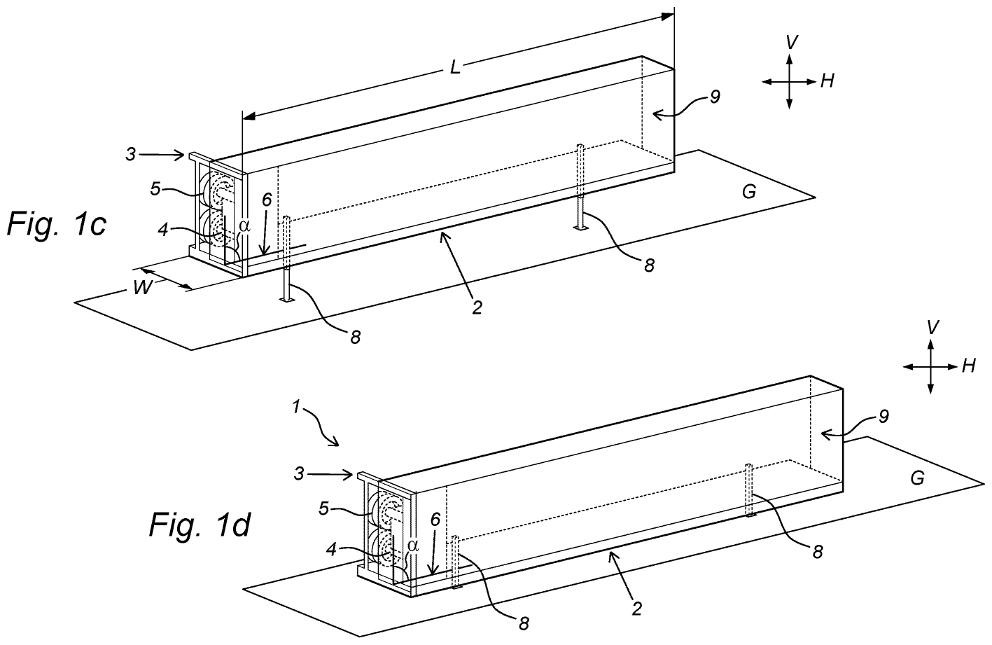

FIGS. 1a-1d show a first possible embodiment of a trailer according to the present invention;

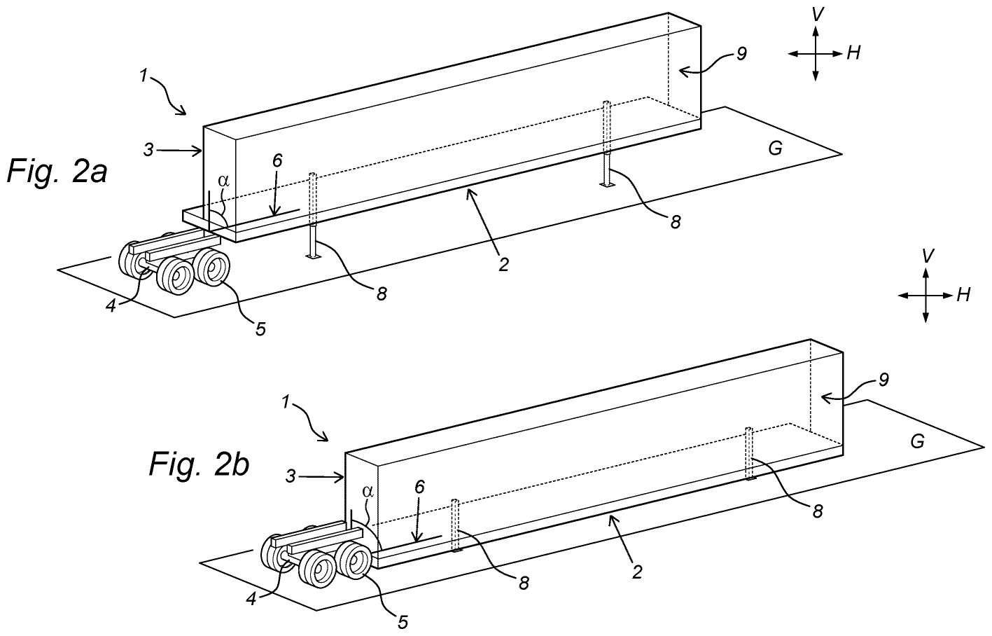

FIGS. 2a and 2b show a second possible configuration of a trailer according to the present invention; and

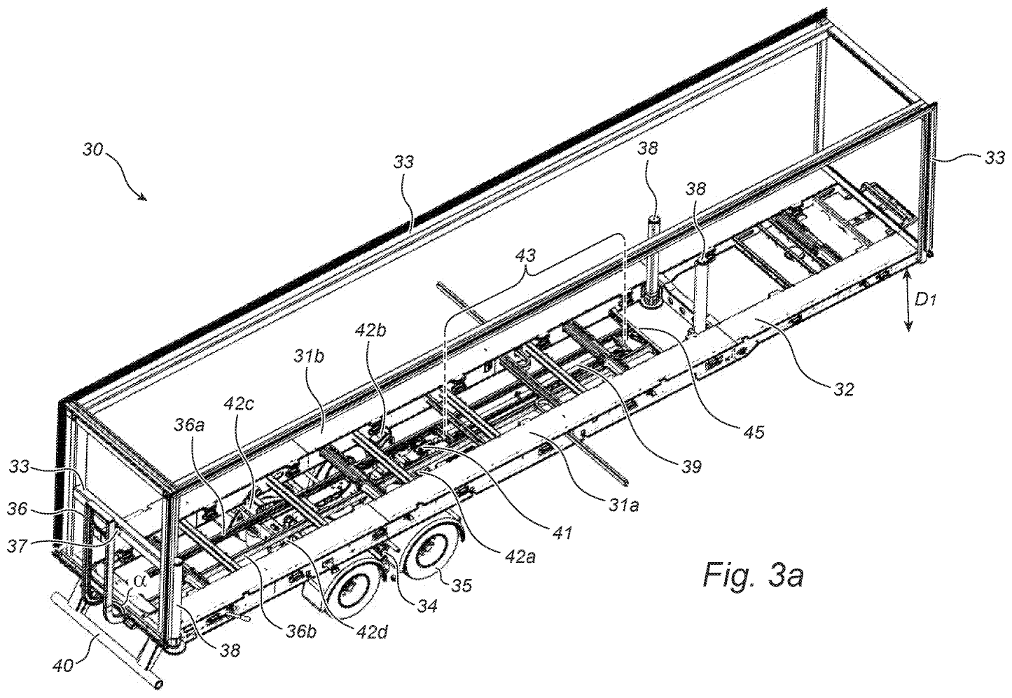

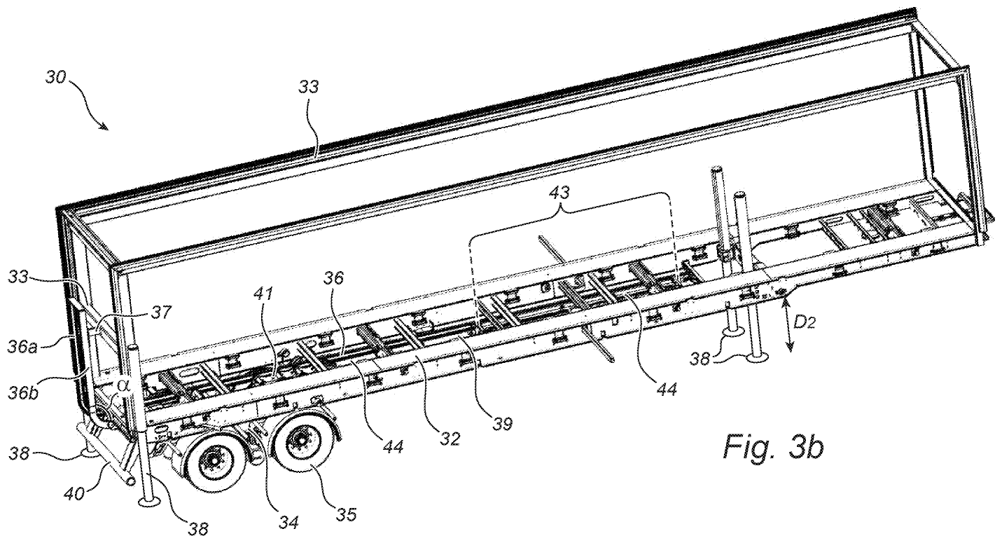

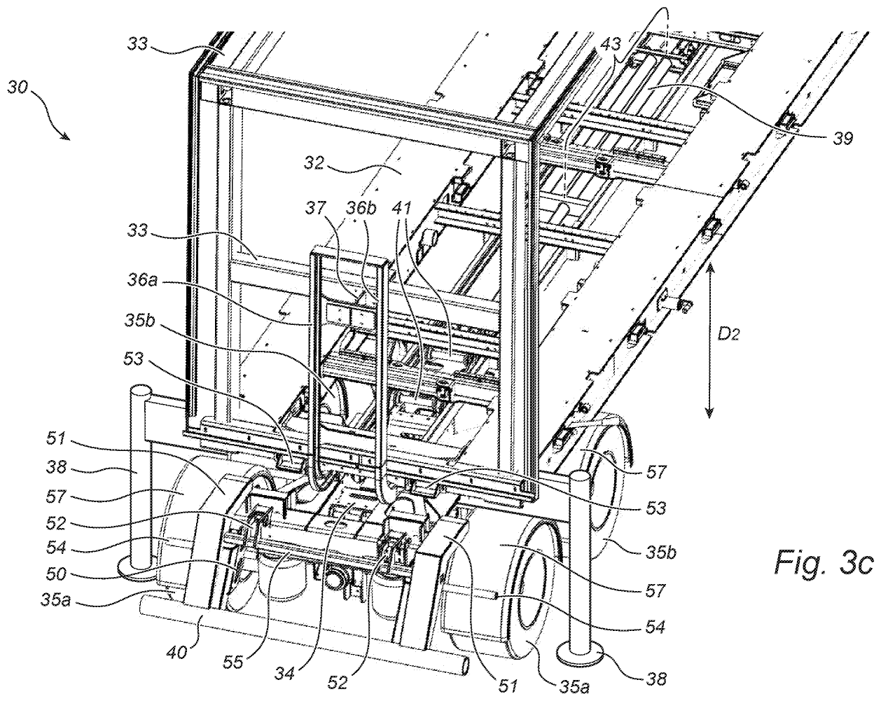

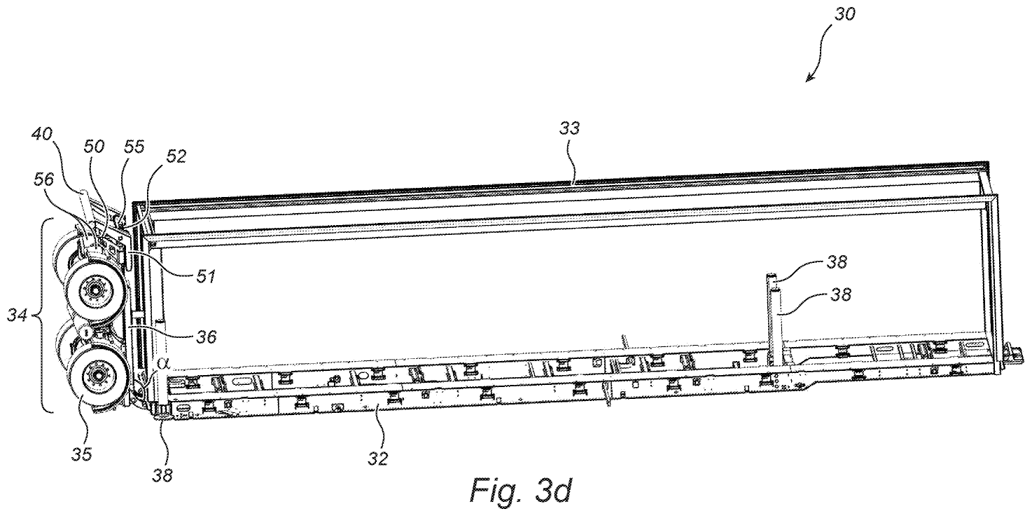

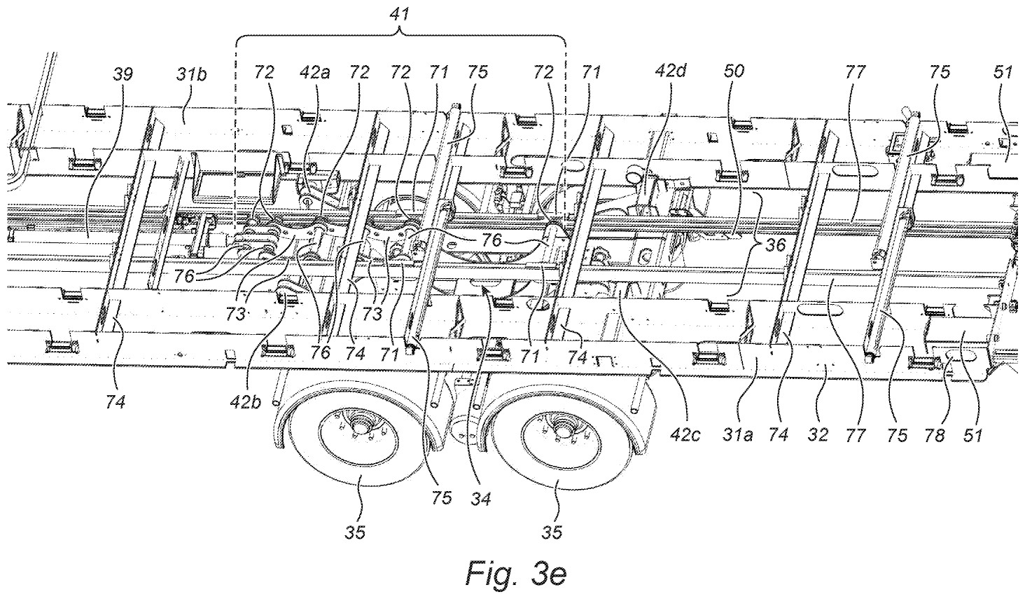

FIGS. 3a-3e show a third possible configuration of a trailer according to the present invention.

Within these figures, similar reference numbers correspond to similar or equivalent elements or features.

FIGS. 1a-1d shows a schematic and perspective view of a first possible embodiment of a trailer (1) according to the present invention. The figures show in particular a sequence wherein the trailer (1) is converted from an initial, driving mode to a stationary, stowed mode. The figures show a trailer (1) with a substantially rectangular-shaped trailer body that comprises a chassis (2) and a bodywork (3). The trailer (1) further comprises at least one wheel axle (4) for at least one pair of wheels (5). The bodywork (3) is located on the upper side of the chassis (2). The bodywork (3) of the trailer (1) comprises multiple side walls (9) which define the volume of the trailer (1). The trailer (1) further comprises a track (6). In the shown embodiment, the track (6) is located both at the bottom side of the chassis (2) and at the side wall (9) of the bodywork (3). The track (6) thereby defines an angle (α) between the track parts. In the shown embodiment, the wheel axle (4) comprises two pairs of wheels (5) which are (displaceably) connected to the track (6). Via this track (6) the wheel axle (4), and thus the wheels (5), are moveable, in particular out of a plane that is substantially defined by the width (W) and length (L) of the chassis (2). Displacement of the wheel axle (4) is for example shown FIGS. 1b and 1c.

The trailer (1) further comprises multiple extendable support members (8), which are configured to extend and retract at least in a vertical direction. FIG. 1a shows a driving mode wherein the support members (8) are in a retracted position. FIG. 1b shows the trailer (1) with the support members (8) in an extended mode. This extended mode of the support members (8) enables the trailer body to lift the wheels (5) from ground level (G). In the shown extended mode, the support members (8) lift the wheels (5) from ground level (G). While the wheels (5) are lifted from ground level (G) is the wheel axle (4) movable along the track (6) on the chassis (2) and on the bodywork (3) of the trailer body.

FIGS. 1c and 1d show the trailer (1) in a configuration wherein the wheel axle (4) is in the stowed position. The wheel axle (4), and thus the wheels (5), are removed from the bottom side of the chassis (2). The wheel axle (4) is moved on the track (6) while the support members (8) are in extended mode. The extended mode of the support members (8) result in the lifting of the bottom side of the chassis (2) to a predetermined distance from ground level (G). The movement of the wheel axle (4) along the track (6) starts with the displacement of the wheel axle (4) on the track (6) in horizontal direction (H) in particular to the rear end of the chassis (2). Subsequently, the wheel axle (4) is displaced in a substantially vertical direction (V) on the vertical part of the track (6) on the rear part of the bodywork (3). This results in the wheel axle (4) being positioned towards and into the stowing position. As a consequence, the wheels (5) (and the wheel axle (4)) are not present at the bottom side of the chassis (2) anymore, thereby leaving a free plane underneath the chassis (2) of the trailer (1). The trailer body could then be brought to ground level (G) by retracting the support members (8), as is shown in FIG. 1d. The retraction of the support members (8) brings the bottom side of the chassis (2) towards ground level (G) and with that the trailer (1) as such. This results in the advantage that the height difference between the bottom surface of the trailer body and the surface whereupon is the trailer (1) is positioned, caused by either the wheels (5) or by the support members (8) when in extended mode, is overcome. The resolving of this height difference makes it easier to enter and leave the trailer (1) for example. Where the illustrative figures show that the wheel axle (4) and the corresponding wheels (5) are stowed into an receiving space defined by the trailer body, it is also conceivable that the trailer (1) comprises a cover element configured for covering at least part of at least one wheel axle (4) in the stowed position.

FIGS. 2a and 2b show another possible embodiment of a trailer (1) according to the present invention. In the figures, a second possible configuration of the stowed position of the wheel axle (4) is shown. The figures indicate the trailer (1) wherein the wheel axle (4), and thus the wheels (5), are removed from the bottom side of the chassis (2) of the trailer (1). The wheel axle (4), comprising a pair of wheels (5), is displaced in a substantial horizontal direction (H) over the track (6) while the support members (8) are in the extended mode to lift the chassis (2), and thus the trailer body, from ground level (G). The wheel axle (4) first moves along the track (6) in horizontal direction (H) to the rear end of the chassis (2). This results in the wheel axle (4) being positioned outside a plane defined by the chassis (2). As a consequence, there will be a substantially free volume underneath the chassis (2). Subsequently, the support members (8) can be retracted, as can been seen in FIG. 2b, which causes the chassis (2) to lower its spatial position towards ground level (G). In this embodiment the wheels (5) stay in contact with ground level (G), outside a plane defined by the chassis (2), whilst the trailer body is lowered such that the height difference of the trailer (1) with the ground level (G) is overcome.

FIGS. 3a, 3b, 3c, 3d and 3e shows a schematic representation of a third possible embodiment of a trailer (30), in particular an expandable trailer (30) according to the present invention. FIG. 3a shows the trailer (30) in a driving mode wherein the wheel axle is in the initial position. FIG. 3b shows the trailer (30) in an intermediate position. FIG. 3c shows a rear view of the trailer (30) wherein the wheel axle is in an intermediate position. FIG. 3d shows a side view of the trailer (30) wherein the wheel axle is in the stowed position. FIG. 3e shows a detailed part of the trailer (30).

FIG. 3a shows that the trailer (30) comprises a chassis (32) and a bodywork (33). In the shown embodiment, the chassis (32) comprises two opposing frame parts (31a, 31b). The frame parts (31a, 31b) longitudinally extend between the rear end and front end of the trailer (30). The wheel axle (34) of the trailer (30) is located substantially between the two frame parts (31a, 31b). The wheel axle (34) is coupled to the chassis (32) via a track (36). The track (36) of this embodiment comprises two opposing track rails (36a, 36b). The track (36) is connected to the chassis (32), and in particular to the two frame parts (31a, 31b) thereof. The track (36) is connected to the chassis (32) by means of a support structure (45). The track (36) is also connected to a displacement element (41). The displacement element (41) is connected to the wheel axle (34). The displacement element (41) is configured to initiate displacement of the wheel axle (34) over the track (36). In the shown embodiment, the displacement element (41) is a chained displacement element (41). The displacement element (41) comprises a chain, or belt, for enabling displacement of the wheel axle (34) over the track (36). The displacement element (41) is at least partially received by at least one of the track rails (36a, 36b), preferably up or under or in the track rails (36a, 36b). The displacement element (41) comprises wheels which are at least partially located in the channel of the track rails (36a, 36b). The trailer (30) further comprises an actuator (39), preferably a hydraulic actuator (39), configured to displace the displacement element (41) and thus the wheel axle (34) over the track (36). The shown embodiment comprises two hydraulic actuators (39) respectively facing the rear end and the front end of the trailer (30). The actuator (39) is received in an actuator bearing structure (43). The actuator bearing structure (43) is at least partially received within the chassis (32), in particular the actuator bearing structure (43) is at least partially received in between the two frame parts (31a, 31b) of the chassis (32). More in particular, the actuator bearing structure (43) is at least partially enclosed by the track (36). The actuator bearing structure (43) is for example positioned substantially up, under and/or in the track rails (36a, 36b). The track (36) extends both in a direction parallel to the longitudinal direction of the chassis (32) and under an angle (α) with respect to the longitudinal direction of the chassis (32). The length of the track (36) that extends under the angle (α) with respect to the longitudinal direction of the chassis (32) is shorter than the length of the track (36) that extends parallel to the longitudinal direction of the chassis (32). The part of the track (36) extending under the angle (α) with respect to the longitudinal direction of the chassis (32) can be connected to the bodywork (33) by a connecting element (37). The trailer (30) comprises a guard (40) at the rear end of the trailer (30). The trailer (30) as shown in FIG. 3a is in an initial position, or driving mode, wherein the support members (38) are retracted and the distance (D1) between the bottom side of the chassis (32) and ground level is such that the wheels (35) make contact with the ground. In this initial position, or driving mode, the wheel axle (34) is secured by securing elements (42a, 42b, 42c, 42d). The securing elements (42a, 42b, 42c, 42d) are configured for locking the wheel axle (34) with respect to the track (36). Therewith, the securing elements (42a, 42b, 42c, 42d) prevent that the wheel axle (34) can be displaced over the track (36) when the wheel axle is in the initial position. The shown embodiment comprises four securing elements (42a, 42b, 42c, 42d) locking the wheel axle (34) with respect to the chassis (32). The securing elements (42a, 42b, 42c, 42d) can be unlocked in case the trailer (30) has to be transferred from the driving mode to the stationary mode.

FIG. 3b shows a perspective view of the trailer (30) as shown in FIG. 3a, in a configuration wherein the wheel axle of the trailer (30) is in an intermediate position. The intermediate position is a position between the initial position and the stowed position. In the shown intermediate position, the wheel axle (34) is located underneath the chassis (32) but displaced towards the rear end of the trailer (30) with respect to the initial position (see FIG. 3a) or displaced towards the front end of the trailer (30) with respect to the stowed position (see FIG. 3d). The support members (38) are extracted such that the distance (D2) between the bottom side of the chassis (32) and ground level is such that the wheels (35) are elevated from the ground. The actuator (39) of the shown embodiment comprises two hydraulic actuators (39) respectively facing the rear end and the front end of the trailer (30). The piston rods (44) of both hydraulic actuators (39) are extended respectively towards the rear end and towards the front end of the trailer (30). Accordingly, the actuator bearing structure (43) is configured to move along the longitudinal direction of the chassis (32). More specifically, the actuator bearing structure (43) is configured to move along the longitudinal direction of the track (36). In this embodiment, the actuator bearing structure (43) moved towards the rear end of the trailer (30) compared to the initial position (see FIG. 3a). Therewith, the wheel axle (34) is displaced towards the rear end of the trailer (30).

FIG. 3c shows a perspective view of the rear end of the trailer (30). In this figure, the trailer (30), and in particular the wheel axle thereof, is still in an intermediate position. In the shown intermediate position the wheel axle (34) is partially positioned outside a printout of a plane defined by the chassis (32). Here, the wheel axle (34) comprises two pairs of wheels (35a, 35b). The figure shows that a first pair of wheels (35a) is positioned outside the printout of the plane defined by the chassis (32) and the second pair of wheels (35b) is positioned underneath the chassis (32). Where FIGS. 3a and 3b show the guard (40) in the driving configuration, it can be seen that the guard (40) is now displaced with respect to that initial position. In fact, the guard (40) is detached from the chassis (32). The guard (40) is displaced such that the way is paved for the wheel axle (34) to allow the displacement towards the stowed position. Upon displacement of the wheel axle (34) over the track (36), the wheel axle (34) comes into contact with the guard (40), wherein a connection between the wheel axle (34) and the guard (40) is realized. The mutual connection is established by the mechanical activation of a secondary coupling element (52). As a consequence of the direct contact between the guard (40) and the wheel axle (34), the guard (40) is attached to the wheel axle (34) by means of a secondary coupling element (52). The secondary coupling element (52) of this embodiment comprises two hooking elements (52) that are configured to grip and connect the guard (40) upon direct contact between the wheel axle (34) and the guard (40). More specifically, in the shown embodiment the hooking elements (52) are configured to grip a beam (55) extending in width direction (x) of the guard (40). Furthermore, the wheel axle (34) comprises a tertiary coupling element (50) configured to be coupled with the guard (40). In this embodiment, the tertiary coupling element (50) is a protruding element (50) configured to be received in a receiving space (not shown) in the guard (40). The guard (40) furthermore comprises a primary coupling element (51) configured to couple the guard (40) with the chassis (32), in particular in a detachable manner. In the shown embodiment, the primary coupling element (51) comprises a bearing surface (51). In the shown intermediate position, the bearing surfaces (51) of the guard (40) are exposed since the guard is decoupled from the chassis (32). In the initial position, the bearing surfaces (51) are accommodated substantially in the chassis (32). The wheel axle (34) further comprises carriers (54) configured to carry wheel well guards (57). In the shown embodiment, the support members (38) are extracted such that the distance (D2) between the underside of the chassis (32) and the ground is such that the wheels (35) are elevated from the ground. Furthermore, the support members (38) are displaced in a direction transversal direction to the chassis (32), or in width direction (x), such that the space between the two support members (38) is enlarged. The support members (38) are displaced over the rear end of the chassis (32). This results in a large enough space on the rear end of the trailer (30) for the wheel axle (34) to pass through. As can be observed, the displacement element (41) is a chained displacement element (41). The displacement element (41) is partially received in the channel of the track rails (36a, 36b).

FIG. 3d shows a side view of the trailer (30) wherein the wheel axle (34) is in the stowed position. In shown embodiment of the stowed position of the wheel axle (34), the chassis (32) is in contact with the ground. The supporting members (38) are therefore retracted. The wheel axle (34) is in the shown configuration positioned outside the printout of the plane defined by the chassis (32). The track (36) extends both in a direction parallel to the longitudinal direction of the chassis (32) and under the angle (α) with respect to the longitudinal direction of the chassis (32). The wheel axle (34) and the guard (40) are positioned under an angle (α) with respect to the chassis (32). The guard (40) is connected to the wheel axle (34) via both the secondary coupling element (52) and the tertiary coupling element (50). The uppermost part of the guard (40) is preferably at or below the uppermost part of the bodywork (33) of the trailer (30). The wheel axle (34) comprises stowed position securing elements (56) configured to lock the wheel axle (34) in stowed position. It can be seen that the both the wheel axle (34) and the guard (40) are positioned at a distance from the chassis (32). The assembly of the wheel axle (34) and the guard (40) is thereby stowed and secured efficiently and safely next to the body work (33).

FIG. 3e shows a detailed view of part of the trailer (30). In the shown embodiment the wheel axle (34) is in the initial position. The wheel axle (34) is locked to the chassis (32) via multiple securing elements (42a, 42b, 42c, 42d). The securing elements (42a, 42b, 42c, 42d) are configured to lock the wheel axle (34) at a specific location, in particular in the initial position, with respect to the chassis (32), preferably such that the wheel axle (34) is locked at a specific location in or on the track (36). In the shown embodiment, each securing element (42a, 42b, 42c, 42d) comprises two parts, in particular a wheel axle securing part and a chassis securing part. The wheel axle securing part is located on a distal side of the wheel axle (34). The chassis securing part is located on an inward facing side of the chassis (32). Upon contact of the wheel axle securing part and the chassis securing part, preferably upon locking the wheel axle securing part and the chassis securing part, the securing element (42a, 42b, 42c, 42d) locks the wheel axle (34) with respect to the chassis (32). The shown trailer (30) comprises four securing elements (42a, 42b, 42c, 42d) forming two pairs of opposing securing elements (42a, 42b; 42c, 42d). The first pair of opposing securing elements (42a, 42b) is located at a distance from the second pair of opposing securing elements (42c, 42d). The first pair of opposing securing elements (42a, 42b) is located at a distance along the longitudinal direction of the chassis (32) from the second pair of opposing securing elements (42c, 42d). The securing elements (42a, 42b, 42c, 42d) are located at or close to the vertices of the wheel axle (34). The chassis (32) comprises two opposing frame parts (31a, 31b) that are connected via crossbars (74). Each pair of securing elements (42a, 42b; 42c, 42d) are configured to lock the wheel axle (34) to both opposing frame parts (31a, 31b) of the chassis (32). The trailer (30) as shown is an expandable trailer (30). The chassis (32) furthermore comprises thereto at least one slider (75) configured to expand the volume of the trailer by extending in transversal direction with respect to the chassis (32). The shown chassis (32) comprises two pairs of sliders (75), wherein each pair of sliders (75) is configured to slide in opposite direction relative to each other. The wheel axle (34) is coupled to the track (36). In this embodiment, the track (36) is a rail (36) comprising of two opposing rail channels (77). The wheel axle (34) is coupled to the rail (36) by means of a displacement element (41). In the shown embodiment, the displacement element (41) is a chained displacement element (41) comprising a plurality of coupled links (73). The links (73) are coupled by means of a link connector (76). Each link connector (76) comprises a roller (72) on both distal ends. The rollers (72) are at least partially received in the channel (77) of the track (36) and in particular of the track rails (36a, 36b). The rollers (72) are configured to displace the wheel axle (34) between the initial position and the stowed position. The width of the channel (77) of the track rails (36a, 36b) is such that the rollers (72) are capable to rotate during the displacement of the wheel axle (34) between the initial position and the stowed position. Each of the opposing channels (77) of the track rails (36a, 36b) comprises at least one broadened portion (71) configured to lift a link connector (76) and preferably therewith the wheel axle (34) in the initial position or driving mode. Each of the opposing channels (77) of the track rails (36a, 36b) of shown embodiment comprises two broadened portions (71). The broadened portions (71) of opposing channels (77) of the track rails (36a, 36b) are aligned, preferably such that the link connector (76) is perpendicular to the channel (77) of the track rails (36a, 36b). The displacement element (41) can be displaced towards the rear end of the trailer upon activation by the actuator (39). The actuator (39) seizes on the displacement element (41). The actuator (39) is configured to linearly displace the displacement element (41) and therewith the wheel axle (34). The chassis (32) comprises a primary complementary coupling element (78) at the rear end of the trailer, wherein the primary coupling element (51) can be received. In the shown embodiment comprises the primary complementary coupling element (78) an accommodation space (78) configured to receive the bearing surface (51) of the guard (not shown).

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. Trailer, in particular an expandable trailer, comprising:
a trailer body, comprising a chassis and a bodywork;
at least one wheel axle for at least one pair of wheels; and
at least one track wherein at least part of the track is connected to the chassis;
wherein at least one wheel axle is coupled to the trailer body via at least one track; and
wherein the wheel axle is displaceable over said track at least between:
an initial position, wherein at least part of the wheel axle is positioned substantially underneath the chassis; and
a stowed position, wherein the wheel axle is positioned outside a plane defined by the chassis.

2. Trailer according to claim 1, wherein in the stowed position, the wheel axle is positioned outside a printout of a plane defined by the chassis.

3. Trailer according to claim 1 or claim 2, wherein at least part of the track is substantially parallel to the plane defined by the chassis and wherein at least part of the track extends under an angle with respect to said plane.

4. Trailer according to any of the previous claims, wherein at least part of the track extends over a side wall of the bodywork.

5. Trailer according to any of the previous claims, wherein a first part of the track is connected to the chassis and wherein a second part of the track is connected to the bodywork.

6. Trailer according to any of the previous claims, wherein at least one track is extendable in length.

7. Trailer according to any of the previous claims, wherein at least one track comprises at least two track rails.

8. Trailer according to any of the previous claims, comprising at least one securing element configured to secure at least one wheel axle with respect to the track at least in the initial position.

9. Trailer according to any of the previous claims, comprising at least one stowed position securing element configured for securing at least one wheel axle in the stowed position.

10. Trailer according to any of the previous claims, wherein at least one wheel axle comprises a right axle part and a left axle part which can be mutually connected at least in the initial position.

11. Trailer according to any of the previous claims, comprising at least two wheel axles, wherein each wheel axle is coupled to the trailer body via at least one track and wherein each wheel axle is displaceable over at least part of the track at least between an initial position, wherein at least part of the wheel axles are positioned substantially underneath the chassis and a stowed position, wherein the wheel axle are positioned outside a plane defined by the chassis.

12. Trailer according to any of the previous claims, comprising at least one pair of extendable support members for supporting the trailer body, wherein the extendable support members are displaceable between an extended position and a retracted position.

13. Trailer according to any of the previous claims, comprising at least one detachable and/or displaceable guard.

14. Trailer according to claim 13, wherein at least one guard is detachably connected or connectable to the chassis.

15. Trailer according to claim 13 or claim 14, wherein at least one guard is detachably connected or connectable to the wheel axle.

16. Trailer according to any of claims 13 to 15, wherein at least one guard is displaceable at least between a driving configuration, wherein the guard is positioned at the rear end of the trailer, and a parked configuration, wherein the guard is positioned outside a plane defined by the chassis.

17. Trailer according to any of claims 13 to 16, wherein at least one guard is displaceable over the track.

18. Trailer according to any of claims 13 to 17, wherein at least one guard comprises at least one primary coupling element which is configured to be coupled to the chassis.

19. Trailer according to any of the previous claims, wherein at least one wheel axle comprises at least one pair of wheels, and wherein the trailer comprises at least one locking element for locking at least one wheel, and preferably each wheel, with respect to the wheel axle.

20. Trailer according to any of the previous claims, wherein the volume of the trailer body is expandable.

21. Trailer according to any of the previous claims, comprising at least one cover element configured for covering at least part of at least one wheel axle in the stowed position.

22. Trailer according to any of the previous claims, wherein the trailer is an unpowered trailer.

23. Trailer according to any of the previous claims, comprising at least one control unit which is configured to control at least the displacement of at least one wheel axle with respect to the track.

24. Trailer according to any of the previous claims, comprising at least one displacement element configured to enable displacement of least one wheel axle with respect to the track, preferably via at least one actuator.

25. Trailer according to claim 24, wherein the displacement element is a chained displacement element.

26. Assembly of at least one track and at least one wheel axle for use in trailer according to any of the previous claims.
